(19) United States
(12) Patent Application Publication
(10) Pub. No.: US 2023/0222322 A1
(43) Pub. Date: Jul. 13, 2023

(54) VIBRATION DATA ANALYSIS WITH FUNCTIONAL NEURAL NETWORK FOR PREDICTIVE MAINTENANCE

(71) Applicant: Hitachi, Ltd., Tokyo (JP)

(72) Inventors: Wei HUANG, San Jose, CA (US); Haiyan WANG, Fremont, CA (US); Qiyao WANG, Los Gatos, CA (US); Ahmed FARAHAT, Santa Clara, CA (US); Chetan GUPTA, San Mateo, CA (US)

(21) Appl. No.: 17/574,208

(22) Filed: Jan. 12, 2022

(51) Int. Cl. G06N 3/04

(52) U.S. Cl. CPC G06N 3/0454

(57) ABSTRACT

An apparatus for predicting a characteristic of a system is provided. The apparatus may include a memory and at least one processor coupled to the memory. The at least one processor may be configured to perform a method including measuring, at a high sample rate, data relating to an operation of the system over a first time period. The method may further include producing a two-dimensional (2D) time-and-frequency input data set by applying a wavelet transform to the measured data. The method may additionally include generating a set of one or more values associated with one or more system characteristics by processing the 2D time-and-frequency input data set using a functional neural network (FNN).

### FIELD

The present disclosure is generally directed to vibrational data analysis and more specifically, to a method, system, apparatus, and software program for predicting a characteristic of a system based on vibrational data analysis.

### RELATED ART

Vibration naturally exists in any machine, even under the best operating conditions. In modern smart industry, vibration data is widely measured in many different domains, including manufacturing and automation industries, railways, and robotics. For example, a robotic manipulator, which is widely used in manufacturing industries, is a complex moving mechanical equipment that operates in 3-dimensional space. The equipment contains multiple components: joints, motor, reduction system, gearbox, bearings, among additional components. Vibration sensors may be mounted on machines to measure their vibration. In the best health condition, a machine may have a “normal” vibration pattern. When there is fatigue or degradation of one or more components of the machine, the vibration pattern may change, which can be used for predictive maintenance. A vibration sensor can be applied to detect failures at the system level and/or at the component level. Effective vibration analysis is crucial in condition monitoring and predictive maintenance, which helps to improve machine performance, reduce downtime and increase productivity.

Vibration data is a type of time series sensor data with high sampling rate. The sampling rate usually ranges from hundreds to thousands of measurements per second. In some domains, the sampling rate may go even higher. Real-world vibration data is usually non-stationary, which is hard to model because of its time varying characteristics (frequency contents keep changing along time). Vibration data analysis aims to determine the rate of oscillations, or the frequency components in the vibration data, and monitor the pattern change over time. Therefore, both frequency-domain feature information and time-domain feature information extracted from the vibration data may be important for developing a vibration data analysis method. Time-domain features represent how the vibration is changing or varying over time. Frequency-domain features reveal how much of the original vibration belongs to each given frequency component. Typical features and or characteristics associated with vibration data in the time domain may include a mean, a variance, a skewness, and/or kurtosis. Typical features and or characteristics associated with vibration data in the frequency domain may include an energy distribution over given components calculated using a Fourier-transform-based method or a wavelet-transform-based method. Useful features are expected to capture patterns that may be used to identify the condition (e.g., the “health”) of the equipment. Predictive maintenance methods aim to extract the important features from vibration data and map the features to the condition and/or “health” of the equipment.

Feature engineering is crucial in conventional predictive maintenance methods, which aim to identify important features by selecting features from the extracted temporal and spectral raw features. However, feature engineering usually requires domain knowledge or lots of preliminary analysis which is time and labor consuming.

Deep learning is becoming more and more popular because of its superiority in learning when given enough training data. Convolutional neural network (CNN), originally proposed for image processing and computer vision, is the most popular deep leaning method applied in vibration data analysis. Through frequency analysis method, 1 dimensional (1D) vibration data can be converted to 2D time-frequency representation, which carries both time and frequency domain information. The time-frequency representation can be regarded as an image and used as input for a CNN-based framework for predictive maintenance. This type of framework could automatically extract representative features from the 2D time-frequency representation of the original vibration data. Normal images have a smallest element called a pixel, which is similar to the 2D representation obtained through Fourier-related method. CNN was originally proposed to process image related problems. However, the CNN framework processes images by slides fixed size masks over the image, which may not be suitable for the 2D representation of vibration data with multiresolution.

To convert 1D vibration data to 2D time-frequency representation, Fourier-related and wavelet-related methods can be applied. Fourier-related method works well for stationary signals where the frequency contents are stable. However, real-world vibration data is usually non-stationary, e.g., has dynamic time varying characteristics. Short Time Fourier Transform (STFT) is the Fourier-related method which divides the original vibration signal into a sequence of equal-sized windows and sequentially applies Fourier transform in each window. Thus, STFT detects the frequency information in local sections of the vibration signal and the change over time, where the window size is fixed and pre-determined. To detect lower frequency components requires larger window size because at least one period of the sinusoid needs to fully fit in the selected frame. Usually, the window size is selected based on the smallest frequency that needs to be detected. For example, if the smallest frequency needs to be detected is 10 Hz, then the smallest window size may be 100 ms. A window smaller than 100 ms could not detect the 10 Hz component correctly. Due to the uncertainty principle, there is a trade-off between time and frequency resolution in time-frequency analysis for signal processing, meaning that one cannot achieve high temporal resolution and frequency resolution at the same time. Large window size provides good frequency resolution but results in poor temporal resolution, which though good for low frequency components, may cause information loss in higher frequency components or transient components in the vibration data. Therefore, the window size needs to be adjusted for different frequencies. However, using STFT, the temporal-spectral resolution over the whole 2D time-frequency representation is fixed, which may cause poor temporal resolution at high frequency components or poor spectral resolution at low frequencies. Accordingly, using a Fourier-related method could capture some of the non-stationary pattern in a vibration signal but cannot obtain the complete picture of the signal.

In this invention, a novel application of a functional neural network (FNN) to do vibration data analysis for predictive maintenance is provided. The FNN may automatically extract features from the time-frequency 2D representation of vibration data by regarding each frequency component in the 2D representation as a functional covariate. The novel application of the FNN may effectively capture the important information on the multiresolution representation of the vibration data on the time frequency plane.

### SUMMARY

Example implementations described herein involve an innovative method for using a functional neural network (FNN) to do vibration data analysis for predictive maintenance. An FNN may be used to automatically extract features from the time-frequency 2D representation of vibration data by regarding each frequency component in the 2D representation as a functional covariate. FNN may be used to effectively capture the important information on a multiresolution representation of the vibration data on a time-frequency plane.

Aspects of the present disclosure include a method for predicting a characteristic of a system. The method may include measuring, at a high sample rate, data relating to an operation of the system over a first time period. The method may also include producing a two-dimensional 2D time-and-frequency input data set by applying a wavelet transform to the measured data. The method may further include generating a set of one or more values associated with one or more system characteristics by processing the 2D time-and-frequency input data set using a functional neural network FNN.

Aspects of the present disclosure include a non-transitory computer readable medium, storing instructions for execution by a processor, which can involve instructions for predicting a characteristic of a system. The instructions for predicting the characteristic of a system may include instructions for measuring, at a high sample rate, data relating to an operation of the system over a first time period. The instructions for predicting the characteristic of a system may include instructions for producing a two-dimensional 2D time-and-frequency input data set by applying a wavelet transform to the measured data. The instructions for predicting the characteristic of a system may include instructions for generating a set of one or more values associated with one or more system characteristics by processing the 2D time-and-frequency input data set using a functional neural network FNN.

Aspects of the present disclosure include a system for predicting a characteristic of a system. The system may include means for measuring, at a high sample rate, data relating to an operation of the system over a first time period. The system may also include means for producing a two-dimensional 2D time-and-frequency input data set by applying a wavelet transform to the measured data. The system may also include means for generating a set of one or more values associated with one or more system characteristics by processing the 2D time-and-frequency input data set using a functional neural network FNN.

Aspects of the present disclosure include an apparatus, which can involve a processor, configured to measure, at a high sample rate, data relating to an operation of the system over a first time period. The processor may also be configured to produce a two-dimensional 21) time-and-frequency input data set by applying a wavelet transform to the measured data. The processor may further be configured to generate a set of one or more values associated with one or more system characteristics by processing the 2D time-and-frequency input data set using a functional neural network FNN.

### BRIEF DESCRIPTION OF DRAWINGS

FIG. 1 includes a first diagram illustrating a Fourier-transform-based representation of vibrational data over time and a second diagram illustrating a wavelet-transform based representation of vibrational data over time.

FIG. 2 illustrates a high-level view of a process of some aspects of the invention.

FIG. 3 illustrates an example one-dimensional (1D) vibrational data being converted into a 2D wavelet-transform-based representation based on a set of wavelets associated with different scaling factors and translational factors.

FIG. 4 illustrates an example architecture of an FNN with three functional neurons on a first layer and two numerical neurons on a second layer.

FIG. 5 illustrates two conceptualizations of an example FNN utilizing multivariate functional principal component (FPCA) and best linear unbiased estimator (BLUE) in a functional neuron.

FIG. 6 illustrates a set of snapshots including a set of component signals associated with different frequency scales.

FIG. 7 illustrates an example of training an FNN based on training data and validating the trained FNN based on a set of validation data.

FIG. 8 illustrates an example application of a trained FNN to a set of vibration data.

FIG. 9 is a diagram illustrating a processing of raw vibration data into an output using multivariate FCPA.

FIG. 10 is a flow diagram of a method for predicting a characteristic of a system.

FIG. 11 is a flow diagram of a method for predicting a characteristic of a system.

FIG. 12 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations described herein involve an innovative method for using an FNN to do vibration data analysis for predictive maintenance. FNNs may be able to handle irregular time series data with heterogeneous granularity across different time series covariates. For example, in some aspects, an FNN is used to perform vibration data analysis for predictive maintenance, which could automatically extract features from the time-frequency 2D representation of vibration data by regarding each frequency component in the 2D representation as a functional covariate. An FNN could effectively capture information relevant to predictive maintenance based on the multiresolution representation of the vibration data on the time-frequency plane. In some aspects, there are two primary steps for applying FNN to do vibration data analysis for predictive maintenance: 1) preprocessing of vibration data and 2) applying FNN to automatically extract features and map features to predictor (e.g., an output variable). For example, the predictor may be a RUL, or a probability of failure.

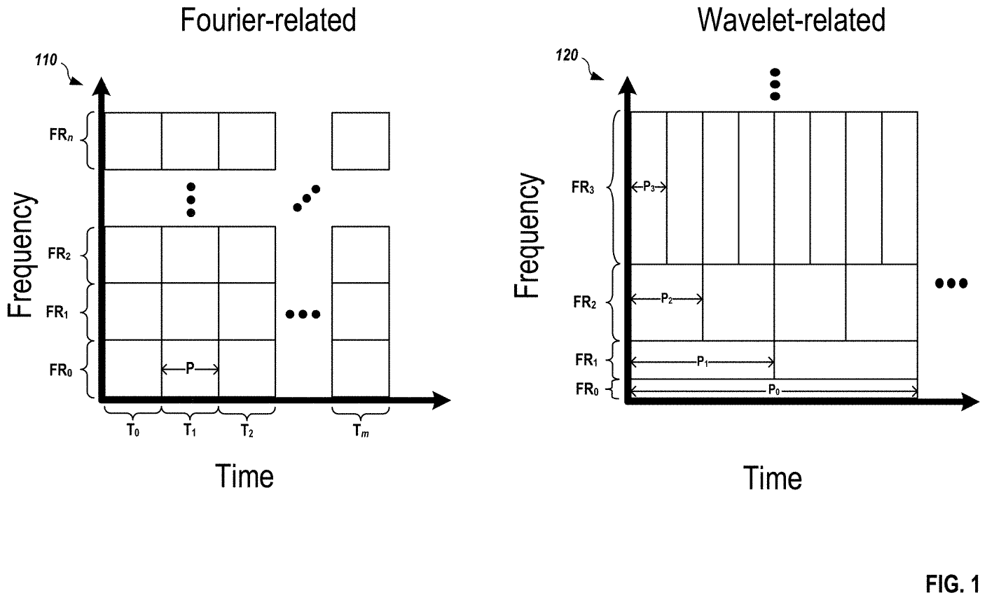

Aspects of the invention described herein may improve predictive maintenance based on vibration data. FIG. 1 includes a first diagram 110 illustrating a Fourier-transform-based representation of vibrational data over time and a second diagram 120 illustrating a wavelet-transform based representation of vibrational data over time. The first diagram 110 illustrates that for each frequency range (e.g., FRᵢ for i=0, . . . , n) a Fourier transform is performed over a set of time periods (e.g., Tⱼ for j=0, . . . , m). As illustrated in diagram each frequency range (e.g., FRᵢ) has a same granularity and each time period (e.g., Tⱼ) has a same period (P). Diagram 120 illustrates that a wavelet-based representation of vibrational data is performed for different frequency ranges (e.g., FR₀, FR₁, FR₂, FR₃, etc.) over different time periods (e.g., P₀, P₁, P₂, P₃, etc.). Accordingly, by adjusting a time period associated with different frequency ranges the wavelet-based representation of vibrational data may be able to identify features at different scales to improve predictive maintenance.

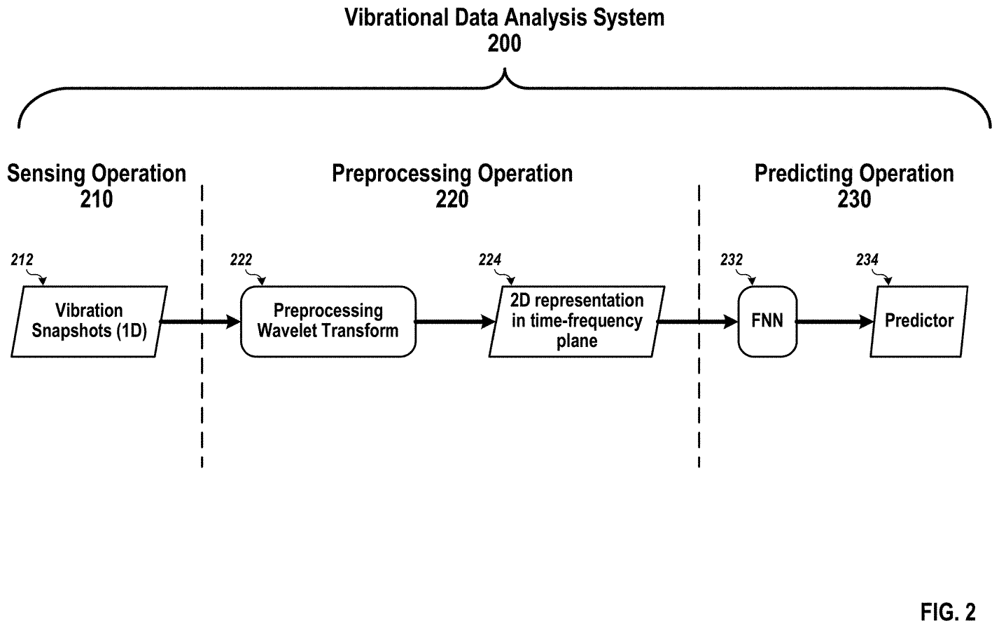

FIG. 2 illustrates a high-level view of a process of some aspects of the invention. FIG. illustrates that a vibrational data analysis system 200 may provide a sensing operation 210, a preprocessing operation 220, and a predicting operation 230. The sensing operation 210 may collect one-dimensional (1D) vibration snapshots 212. The 1D vibration snapshots 212, in some aspects, are collected by one or more sensors associated with one or more components of a machine or system for which predictive maintenance will be performed. In some aspects, the 1D vibration snapshots 212 are portions of a continuous stream of 1D vibration data.

A preprocessing operation 220 may receive the 1D vibration snapshots 212 from a sensor and apply a preprocessing wavelet transform 222 to convert the 1D vibration snapshots 212 to a 2D representation in a time-frequency plane 224. The 2D representation in a time-frequency plane 224 may include component signals formed through the convolution of the original 1D vibration snapshots 212 with a series of functions at different frequencies generated by a translation and scaling of a source function. In some aspects, a wavelet transform (e.g., preprocessing wavelet transform 222) of a signal may be its inner product with a scaled and shifted version of a given function, which is called a mother wavelet. For example, for a function, f(t), denoting a signal (e.g., 1D vibration snapshots 212) to be analyzed, and ψ denoting the given mother wavelet function, the wavelet transformation of f(t) at a scale a∈ [symbol] ⁺ and translational value b∈ [symbol] is expressed by the following integral:

$${W}_{ψ} f ( a , b ) = {\vert a \vert}^{- \frac{1}{2}} \int \overline{ψ ( \frac{t - b}{a} )} f ( t ) dt$$

where the scale factor a controls the dilation or compression and the translational factor b controls the position of a center of the scaled mother wavelet, ψ, with respect to the signal, f(t), to be analyzed.

After the preprocessing step (e.g., preprocessing wavelet transform 222), the component signals (e.g., the 2D representation in a time-frequency plane 224) may be regarded as functional covariates for providing to the FNN processing 232. The FNN processing 232 may be part of a predicting operation 230 for producing a predictor 234. The predictor 234 may include one or more of a predicted RUL, a probability of failing within a subsequent time period, or a detected anomaly.

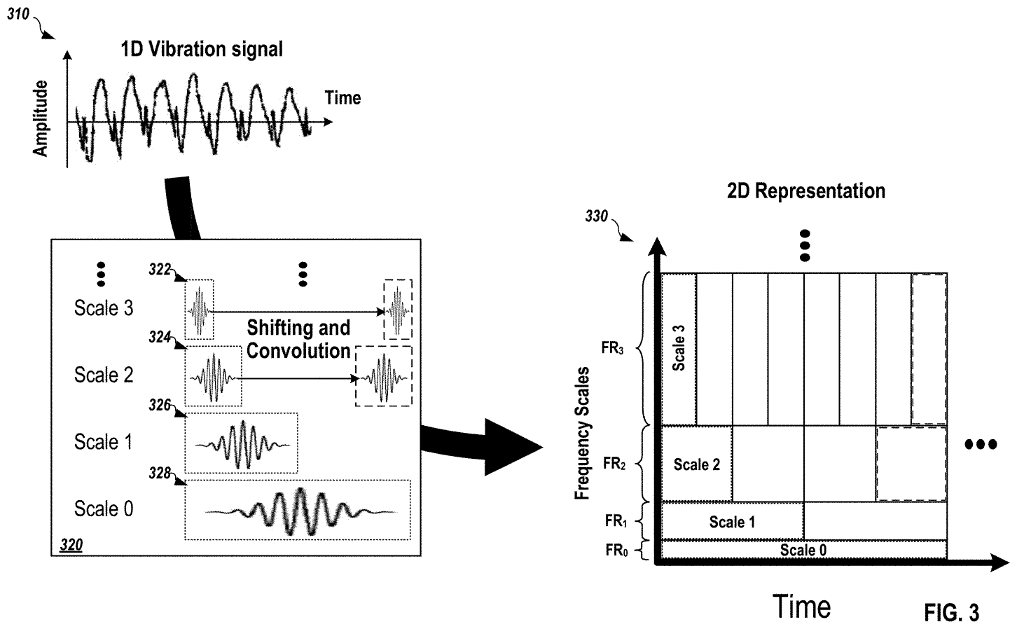

FIG. 3 illustrates example 1D vibration signal 310 being converted into a 2D wavelet-transform-based representation 330 based on a set of wavelets (e.g., wavelets 322, 324, 326, and 328) associated with different scaling factors (e.g., a) and translational factors (e.g., b). The 1D vibration signal 310 may be based on measuring vibrational data, at a high sample rate (e.g., 1-100 kHz) over a first time period (or multiple contiguous time periods). In some aspects, the first time period may be divided into a set of time periods at each of a plurality of scales (e.g., scales 0-3) with each scale in the plurality of scales corresponding to a range of frequencies represented in the 2D time-and-frequency input data set.

As described in relation to FIG. 2, a preprocessing operation 320 (e.g., the preprocessing operation 220) may receive the 1D vibration signal 310 and apply the wavelet transform to the measured data (e.g., the 1D vibration signal 310) to produce a 2D time-and-frequency input data set (e.g., the 2D wavelet-transform based representation 330). In some aspects, applying the wavelet transform includes applying, to each set of time-windows at each of the plurality of scales, a wavelet associated with the range of frequencies (e.g., FR₀, FR₁, FR₂, FR₃, etc.) corresponding to the scale in the plurality of scales. In some aspects, each set of time-windows is a set of equal-size time-windows and the wavelet associated with each range of frequencies spans the equal-size time-windows in the set of equal-size time-windows associated with the range of frequencies.

Functional data analysis (FDA) is a rapidly growing branch of statistics specialized in representing and modeling dynamically varying data over a continuum. An FNN may be introduced with the purpose of learning complex mappings between functional covariates and scalar responses from independent and identically distributed random variables (or data samples).

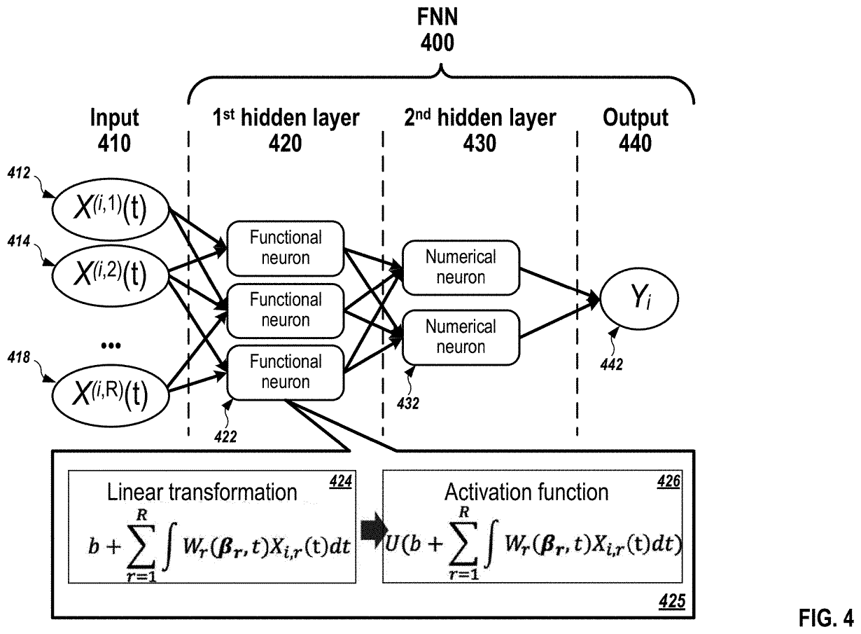

FIG. 4 illustrates an example architecture of an FNN 400 with three functional neurons (e.g., functional neuron 422) on a first layer 420 and two numerical neurons (e.g., numerical neuron 432) on a second layer. The first layer 420 of functional neurons 422 of FNN 400 receives input 410 (e.g., including functional covariates X^{(i,1)}(t) 412, X^{(i,2)}(t) 414, . . . X^{(i,R)}(t) 418) based on a 2D wavelet-transform based representation of a set of 1D vibration data. The first layer 420 of the FNN 400 may consist of novel functional neurons 422.

The functional neurons 422 may take the functional covariates Xᵢ(t)=[X^{(i,1)}(t), . . . , X^{(i,R)}(t)]^{T} as input, and may calculate a set of functions 425 including a linear transformation 424 (e.g., Σᵣ₌₁^{R}∫_{t∈T}Wᵣ(βᵣ, t)X^{(i,r)}(t)dt) of the input data based on a parameter function Wᵣ(βᵣ, t) for r=1, . . . , R (e.g., a set of trainable parameters, or weights, associated with each X^{(i,r)} for r=1, . . . , R), where βᵣ is a finite-dimensional vector that quantifies the parameter function Wᵣ(βᵣ,t). The functional neurons 422 may then calculate a scalar value based on an activation function 426

$$H ( {X}_{i} ( t ) , β ) = U ( b + {\sum }_{r = 1}^{R } {\int }_{t ∈ T} {W}_{r} ( {β}_{r} , t ) {X}^{( i , r )} ( t ) dt )$$

where b∈ [symbol] is an unknown intercept, and U(⋅) is a nonlinear activation function from [symbol] to [symbol] . The calculated scalar values (e.g., based on the activation function 426 H(Xᵢ(t), β)) are the features in the new space which are then supplied into subsequent layers (e.g., the second layer 430) of numerical neurons 432 for further manipulations. In some aspects, additional layers of functional neurons and/or numerical neurons may be included in the FNN. The second layer 430 of numerical neurons 432 (e.g., a last layer of an FNN) may generate an output 442 (e.g., Yᵢ) at an output layer 440. The output 442, Yᵢ, may include one or more of a predicted RUL, a probability of failing within a subsequent time period, or a detected anomaly.

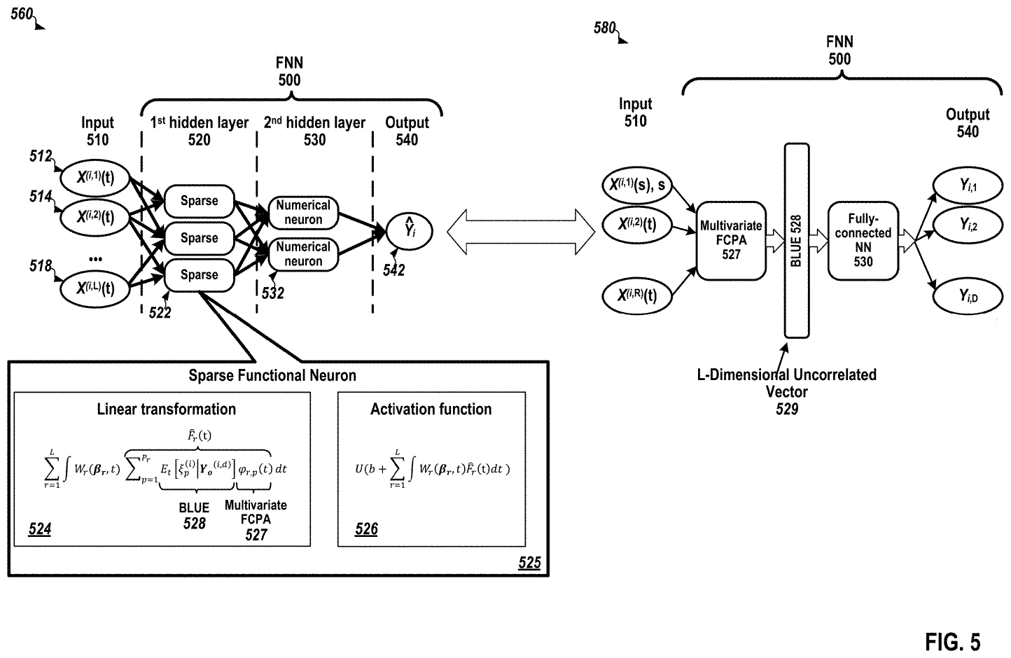

In some aspects, the functional neurons 422 may use multivariate functional principal component (FPCA) and/or best linear unbiased estimator (BLUE) to project the input data to an uncorrelated feature space. FIG. 5 illustrates two conceptualizations 560 and 580 of an example FNN 500 utilizing multivariate FPCA 527 and BLUE 528 in a functional neuron (e.g., a sparse functional neuron 522). The view 560 illustrates similar stages and/or components as the FNN 400 of FIG. 4. For example, inputs 510 correspond to inputs 410 (e.g., including equivalent functional covariates X^{(i,1)}(t) 412/512, X^{(i,2)}(t) 414/514, . . . X^{(i,R)}(t) 418/X^{(i,L)}(t) 518), the first layer 520 of sparse functional neurons 522 corresponds to first layer 420 with functional neurons 422, the second layer 530 of numerical neurons 532 corresponds to second layer 430 of numerical neurons 432, and the output layer 540 (and output 542, Ŷᵢ) corresponds to the output layer 440 (and output 442, Yᵢ). Similarly, a sparse functional neurons 522 utilizes a set of equations 525 including a linear function 524 and an activation function 526. However, the linear function 524 (e.g., Σᵣ₌₁^{L}∫Wᵣ(βᵣ, t)Σₚ₌₁^{P}^{ᵣ}Eₜ[ξₚ⁽ⁱ⁾|Y₀^{(i,d)}]φ_{r,p}(t)dt) includes a multivariate FCPA component 527 (e.g., φ_{r,p}(t)) and a BLUE component 528 (e.g., Eₜ[ξₚ⁽ⁱ⁾|Y₀^{(i,d)}]) not illustrated in FIG. 4. Accordingly, the activation function 526 (e.g., H(Xᵢ(t),β)=U(b+Σᵣ₌₁^{L}∫Wᵣ(βᵣ,t)\hat{F}ᵣ (t)dt), where \hat{F}ᵣ(t)=Eₜ[ξₚ⁽ⁱ⁾|Y₀^{(i,d)}]φ_{r,p}(t)) is based on both the multivariate FPCA 527 and the BLUE 528. The alternate view 580 illustrates an alternative view of the FNN 500 in which the inputs 510 are processed by a multivariate FCPA 527, then by a BLUE 528 (e.g., producing an L-dimensional uncorrelated vector) and finally by the fully-connected neural network (FCNN) 530 (e.g., representing the second layer 530 of the numerical neurons 532)

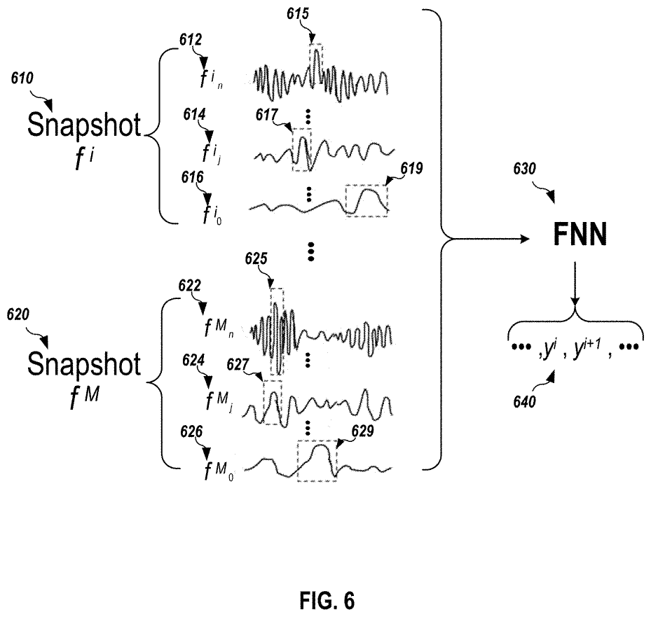

FIG. 6 illustrates a set of snapshots 610 and 620 including a set of component signals associated with different frequency scales. In some aspects, vibration data used in a model training stage is in the format of {fᵢ, yᵢ}, i=1, . . . , M, where a snapshot fᵢ 610 is the snapshot of vibration measurements at timestamp i, yᵢ 640 is the prediction target (such as RUL or probability of failure) at timestamp i, and M is the total number of snapshots. The duration of each snapshot may be specified in a data acquisition stage (e.g., sensing operation 210). Assuming that the duration is τ and sampling frequency is FS. The number of samples in each snapshot is N=τ×FS. In the preprocessing step, the original vibration data fᵢ may be transformed into a series of component signals [f₀ⁱ, f₁ⁱ, . . . , fₙⁱ], where the subscript indicates the frequency scale in a set of n+1 frequency scales. In some aspects using a continuous wavelet transform, the component signals may have a same number of samples. Although the sample granularity in the component signals may be the same, the patterns carried by different components may have different granularity, as shown in FIG. 6. The information in a lower frequency scale component may changes more slowly (e.g., changes may be noticeable over a larger time step), while the information in a higher frequency scale component may change more quickly (e.g., changes may be noticeable over a larger time interval). The vibration measurements in different snapshots may not be aligned in time, such that important information could be located at different times in different snapshot samples, as shown in FIG. 6 where the information in the dashed boxes (e.g., dashed boxes 615, 617, 619, 625, 627, and 629) is assumed to be the important patterns for predictive maintenance tasks. Conventional neural network may be focused on detecting the local features, which may not be suitable for the vibration component signals which have significantly different information/pattern granularity. In some aspects, an FNN is more focused on detecting global picture. The FNN 630 takes the component signals [f₀ⁱ . . . , fⱼⁱ, . . . , fₙⁱ], i=1, . . . M as input, captures the patterns with varying granularity in different frequency scales, and maps the patterns to a corresponding predictor yᵢ, i=1, . . . M 640.

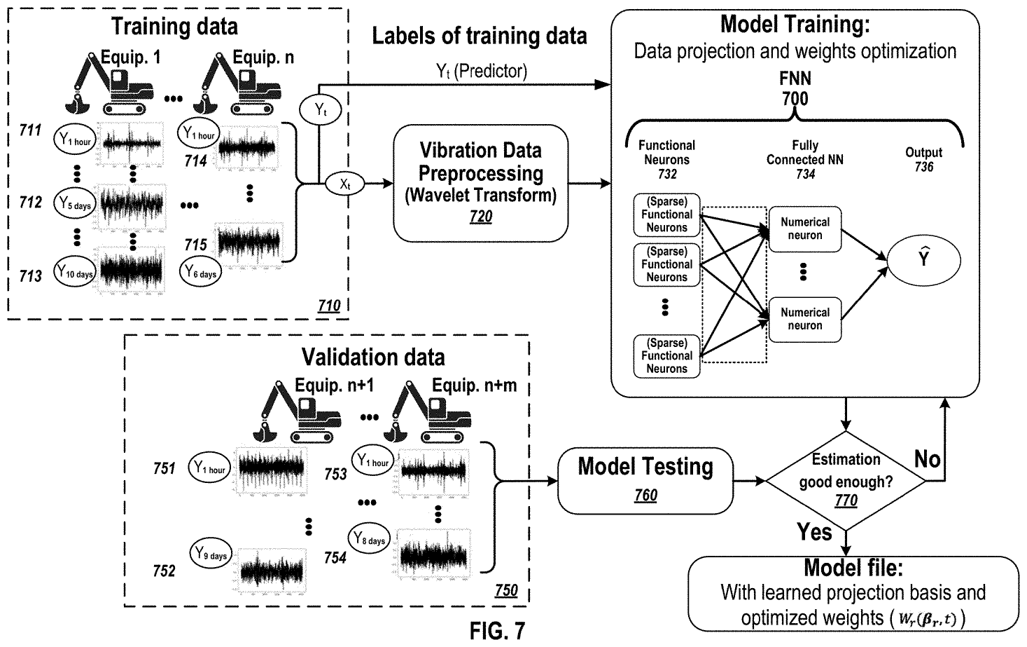

FIG. 7 illustrates an example of training an FNN 700 based on training data 710 and validating the trained FNN based on a set of validation data 750. In some aspects, a learning data set includes vibration data measured from n+m machines as well as information regarding the occurrence of a failure relative to the times at which the vibration data was captured (e.g., information allowing an RUL, or probability of failure, associated with each snapshot to be calculated). The learning data may be split into training data 710 and validation data 750, where the training data 710 is used to train and/or optimize model parameters (e.g., including a set of weights) and the validation data 750 is used for model evaluation to prevent over fitting or under fitting.

The training data 710 may include training data sets 711-715 (e.g., sets of snapshots (e.g., Xₜ) and associated predictors (e.g., Yₜ)). The training data may be based on recorded vibration data and known times to failure from each snapshot, e.g., when predicting a RUL or a probability of failure. Training the FNN 700 may include training a set of weights (e.g., Wᵣ(βᵣ, t)) associated with a set of functional neurons 732. To train the FNN 700, a particular snapshot (e.g., Xₜ) is selected from the set of training data 710 (e.g., an Xₜ associated with one of the training data sets 711-715) and processed via vibration data preprocessing (e.g., wavelet transform) 720 to generate input for the FNN 700. The input may be provided to the FNN to produce an output 736 (e.g., a predictor value). The output 736 may then be compared to a predictor associated with the snapshot (e.g., Yₜ) to determine a difference between the computed output 736 and the known predictor from the set of training data 710 for a backpropagation operation. The backpropagation operation, in some aspects, includes adjusting set of weights based on a magnitude of the difference between the calculated predictor value 736 and the know predictor value from training data 710 and based on a gradient associated with the activation function.

After training the data with the training data 710, the trained FNN 700 may be validated based on a second set of validation data 750. Similarly to the training data 710, the validation data 750 may include validation data sets 751-754 including sets of snapshots and associated predictors. In order to validate the trained FNN, in some aspects, one or more snapshots in the set of validation data may be preprocessed to generate an input data set for the trained FNN 700 as described in relation to vibration data preprocessing (e.g., wavelet transform) 720 and provided to the trained FNN 700 as part of model testing 760 to produce one or more corresponding output(s) 736. The output(s) 736 (e.g., predictor value) may then be compared to the known predictor value associated with each of the one or more snapshots and a determination 770 is made as to whether the computed value is sufficiently close to the known value. If the value is close enough (e.g., if the difference is below a threshold value) the trained FNN 700 is stored as a model file with optimized weights and parameters. If the value is not close enough (e.g., the difference is above a threshold value), another round of training may be initiated using training data 710 or a different set of training data (not shown).

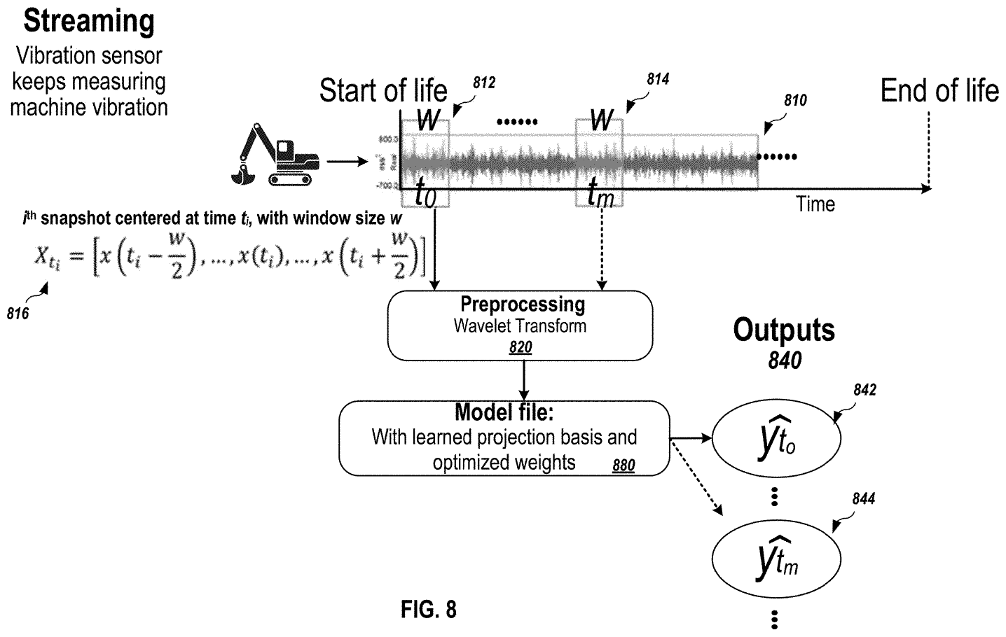

FIG. 8 illustrates an example application of the trained FNN (e.g., model file 880) to a set of vibration data 810. For example, vibration data may be measured in streaming mode over a first time period that may be divided into a set of time-windows (e.g., windows 812 and 814 of length W) at each of a plurality of scales with each scale in the plurality of scales corresponding to a range of frequencies, e.g., as described in relation to FIG. 3. The vibration data associated with a window of width w centered at time tᵢ may be a set of samples 816

$$( e . g . , {X}_{{t}_{i}} = [ x ( v - \frac{w}{2} ) , … , x ( {t}_{i} ) , … , x ( {t}_{i} + \frac{w}{2} ) ] )$$

and each snapshot may be processed via vibration data preprocessing (e.g., wavelet transform) 820 in order to generate a 2D time-and-frequency input data set. The 2D time-and-frequency input data set associated with a particular time, tᵢ, (e.g., a snapshot centered at time tᵢ) maybe processed based on the model file 880 to produce an output (e.g., output 950 associated with time to or output 944 associated with time tₘ in the set of outputs 840.

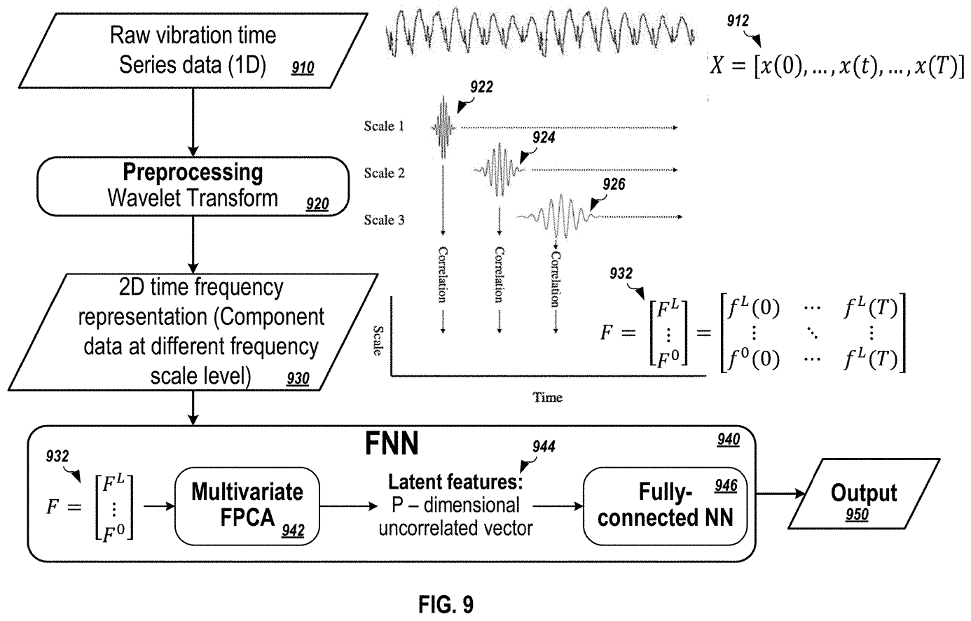

FIG. 9 is a diagram illustrating a processing of raw vibration data 910 into an output 950 using multivariate FCPA 942. Raw vibration data 910 (e.g., a 1D time series data, X=[x(0), . . . , x(t), . . . , x(T)] 912, for data captured from a time 0 to a time T at a given sampling rate) may undergo preprocessing 920 via a wavelet transform using wavelets at different scales (e.g., wavelets 922-926). The preprocessing may generate a 2D time-and-frequency representation 930

$$( e . g . , F = [ \begin{matrix}{F}^{L} \\ … \\ {F}^{0}\end{matrix} ] 932 )$$

that is provided to an FNN 940. The FNN 940 may process the input data through a multivariate FCPA 942 to produce a p-dimensional uncorrelated vector 944 that may then be provided as input to a FCNN 946 to produce one or more outputs 950 (e.g., a predictor value associated with one of an RUL, a probability of failure, or an anomaly score).

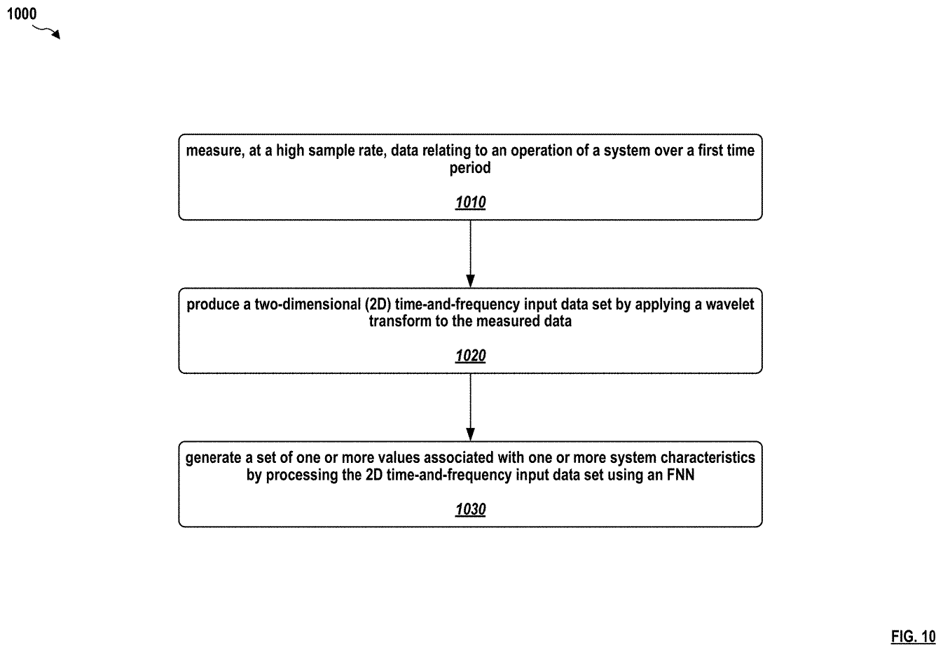

FIG. 10 is a flow diagram 1000 of a method for predicting a characteristic of a system. The method may be performed by an apparatus for capturing and analyzing vibration data associated with a system (e.g., robotic arms, railways, a rotating machine, static equipment, or other system experiencing vibration) or one or more components of a system. At 1010, the apparatus may measure, at a high sample rate, data relating to an operation of the system over a first time period. The measured data, in some aspects, may be one of (1) vibration data, (2) acoustic data, or (3) other time-varying data relating to an operation of the system. Measuring the data, in some aspects, may include measuring the data relating to the operation of the system by continuously measuring the data, at the high sample rate (e.g., 100 Hz to 100 kHz), over the first time period. In some aspects, the first time period may be divided into a set of time-windows at each of a plurality of scales with each scale in the plurality of scales corresponding to a range of frequencies represented in the 2D time-and-frequency input data set. Each set of time-windows, in some aspects, is a set of equal-size time-windows and the wavelet associated with each range of frequencies spans the equal-size time-windows in the set of equal-size time-windows associated with the range of frequencies. For example, for a first (lower frequency) scale, the first time period may be divided into a set of equal size (e.g., 1 second) time windows, while for a second (higher frequency) scale the first time period may be divided into a second set of equal size (100 millisecond) time windows. For example, referring to FIGS. 2, 3, 6, 7, and 9, the apparatus may capture the vibrational snapshots, vibration signal, and/or vibration data 212, 310, 610, 620, 710, 750, 910, or 912.

At 1020, the apparatus may produce a 2D time-and-frequency input data set by applying a wavelet transform to the measured data. In some aspects, applying the wavelet transform includes applying, to each set of time-windows at each of the plurality of scales, a wavelet associated with the range of frequencies corresponding to the scale in the plurality of scales. For example, referring to FIGS. 2, 3, 8, and 9, a preprocessing operation 220, 320, 820, or 920 may perform a preprocessing wavelet transform 222 to produce a 2D representation in a time-frequency plane or a 2D wavelet-transform based representation 224, 330, or 930.

Finally, at 1030, the apparatus may generate a set of one or more values associated with one or more system characteristics by processing the 2D time-and-frequency input data set using an FNN. In some aspects, generating the one or more values includes providing the 2D time-and-frequency input data set to the FNN as input, generating, using the FNN, an output data set, and providing the output data set as an input to a fully connected neural network (FCNN), wherein the generated set of one or more values associated with the one or more system characteristics is the output of the FCNN. The output data set, in some aspects, is associated with a set of latent features of the 2D time-and-frequency input data set that may be identified by the FNN. The generated one or more system characteristics may include at least one of an RUL of the system, a probability of failing within a second time period following the first time period, or a detected anomaly (e.g., a value associated with a detected anomaly or an indication of an anomaly in a set of possible anomalies).

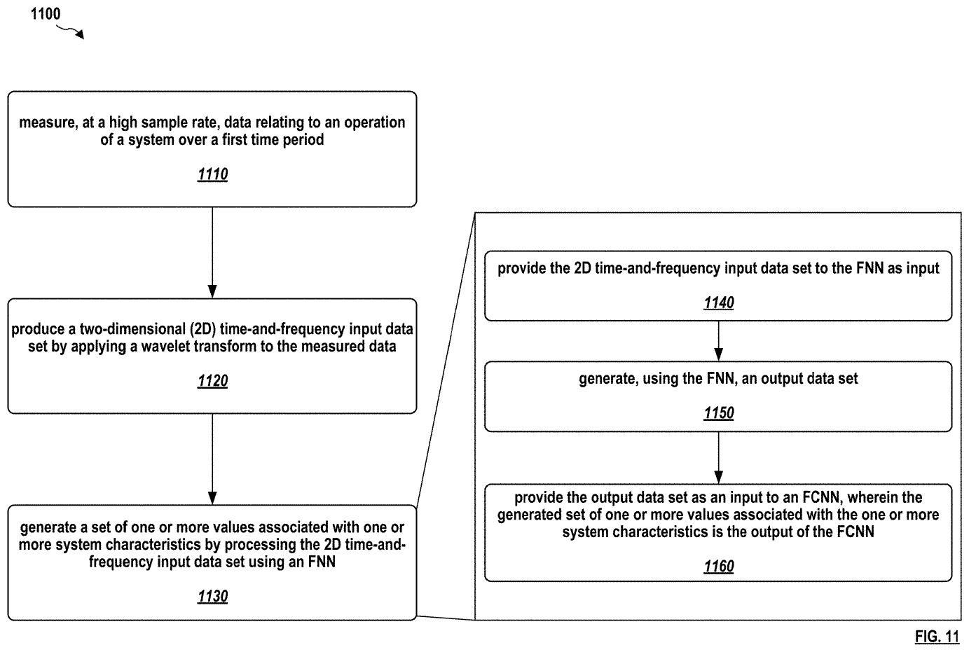

FIG. 11 is a flow diagram 1100 of a method for predicting a characteristic of a system. The method may be performed by an apparatus for capturing and analyzing vibration data associated with a system (e.g., robotic arms, railways, a rotating machine, static equipment, or other system experiencing vibration) or one or more components of a system. At 1110, the apparatus may measure, at a high sample rate, data relating to an operation of the system over a first time period. The measured data, in some aspects, may be one of (1) vibration data, (2) acoustic data, or (3) other time-varying data relating to an operation of the system. Measuring the data, in some aspects, may include measuring the data relating to the operation of the system by continuously measuring the data, at the high sample rate (e.g., 110 Hz to 110 kHz), over the first time period. In some aspects, the first time period may be divided into a set of time-windows at each of a plurality of scales with each scale in the plurality of scales corresponding to a range of frequencies represented in the 2D time-and-frequency input data set. Each set of time-windows, in some aspects, is a set of equal-size time-windows and the wavelet associated with each range of frequencies spans the equal-size time-windows in the set of equal-size time-windows associated with the range of frequencies. For example, for a first (lower frequency) scale, the first time period may be divided into a set of equal size (e.g., 1 second) time windows, while for a second (higher frequency) scale the first time period may be divided into a second set of equal size (100 millisecond) time windows. For example, referring to FIGS. 2, 3, 6, 7, and 9, the apparatus may capture the vibrational snapshots, vibration signal, and/or vibration data 212, 310, 610, 620, 710, 750, 910, or 912.

At 1120, the apparatus may produce a 2D time-and-frequency input data set by applying a wavelet transform to the measured data. In some aspects, applying the wavelet transform includes applying, to each set of time-windows at each of the plurality of scales, a wavelet associated with the range of frequencies corresponding to the scale in the plurality of scales. For example, referring to FIGS. 2, 3, 8, and 9, a preprocessing operation 220, 320, 820, or 920 may perform a preprocessing wavelet transform 222 to produce a 2D representation in a time-frequency plane or a 2D wavelet-transform based representation 224, 330, or 930.

Finally, at 1130, the apparatus may generate a set of one or more values associated with one or more system characteristics by processing the 2D time-and-frequency input data set using an FNN. In some aspects, generating the one or more values includes providing, at 1140, the 2D time-and-frequency input data set to the FNN as input. For example, referring to FIG. 5, a set of inputs 510 may be provided to a set of functional neurons in a first layer 520 (e.g., sparse functional neuron 522).

At 1150, the apparatus may generate, using the FNN, an output data set. The output data set, in some aspects, is associated with a set of latent features of the 2D time-and-frequency input data set that may be identified by the FNN. For example, referring to FIGS. 5 and 9, the apparatus may generate the L-dimensional uncorrelated vector 529 or the P-dimensional uncorrelated vector 944. After generating the output data set, the apparatus may provide, at 1160, the output data set as an input to a fully connected neural network (FCNN) to generate the set of one or more values associated with the one or more system characteristics. For example, referring to FIGS. 5 and 9, the L-dimensional uncorrelated vector 529 or the P-dimensional uncorrelated vector 944 may be provided to the FCNN 530 or 946 to generate a set of outputs 540 or 950. The generated one or more system characteristics may include at least one of an RUL of the system, a probability of failing within a second time period following the first time period, or a detected anomaly (e.g., a value associated with a detected anomaly or an indication of an anomaly in a set of possible anomalies). In some aspects, the apparatus may repeat the operations 1110 to 1130 for additional time periods to produce an additional set of one or more system characteristics associated with the additional time periods.

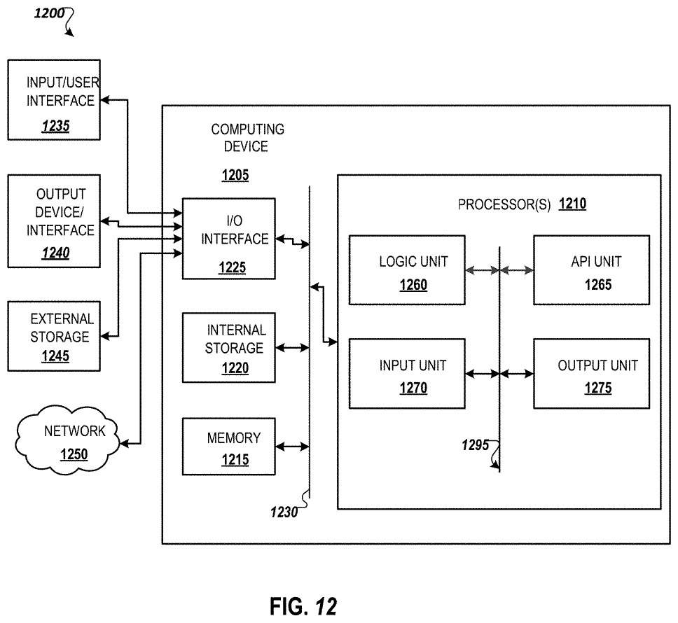

FIG. 12 illustrates an example computing environment with an example computer device suitable for use in some example implementations. Computer device 1205 in computing environment 1200 can include one or more processing units, cores, or processors 1210, memory 1215 (e.g., RAM, ROM, and/or the like), internal storage 1220 (e.g., magnetic, optical, solid-state storage, and/or organic), and/or IO interface 1225, any of which can be coupled on a communication mechanism or bus 1230 for communicating information or embedded in the computer device 1205. IO interface 1225 is also configured to receive images from cameras or provide images to projectors or displays, depending on the desired implementation.

Computer device 1205 can be communicatively coupled to input/user interface 1235 and output device/interface 1240. Either one or both of the input/user interface 1235 and output device/interface 1240 can be a wired or wireless interface and can be detachable. Input/user interface 1235 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1240 may include a display, television, monitor, printer, speaker, braille, or the like. In some example implementations, input/user interface 1235 and output device/interface 1240 can be embedded with or physically coupled to the computer device 1205. In other example implementations, other computer devices may function as or provide the functions of input/user interface 1235 and output device/interface 1240 for a computer device 1205.

Examples of computer device 1205 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1205 can be communicatively coupled (e.g., via 10 interface 1225) to external storage 1245 and network 1250 for communicating with any number of networked components, devices, and systems, including one or more computer devices of the same or different configuration. Computer device 1205 or any connected computer device can be functioning as, providing services of, or referred to as a server, client, thin server, general machine, special-purpose machine, or another label.

IO interface 1225 can include but is not limited to, wired and/or wireless interfaces using any communication or IO protocols or standards (e.g., Ethernet, 1202.11x, Universal System Bus, WiMax, modem, a cellular network protocol, and the like) for communicating information to and/or from at least all the connected components, devices, and network in computing environment 1200. Network 1250 can be any network or combination of networks (e.g., the Internet, local area network, wide area network, a telephonic network, a cellular network, satellite network, and the like).

Computer device 1205 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1205 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1210 can execute under any operating system (OS) (not shown), in a native or virtual environment. One or more applications can be deployed that include logic unit 1260, application programming interface (API) unit 1265, input unit 1270, output unit 1275, and inter-unit communication mechanism 1295 for the different units to communicate with each other, with the OS, and with other applications (not shown). The described units and elements can be varied in design, function, configuration, or implementation and are not limited to the descriptions provided. Processor(s) 1210 can be in the form of hardware processors such as central processing units (CPUs) or in a combination of hardware and software units.

In some example implementations, when information or an execution instruction is received by API unit 1265, it may be communicated to one or more other units (e.g., logic unit 1260, input unit 1270, output unit 1275). In some instances, logic unit 1260 may be configured to control the information flow among the units and direct the services provided by API unit 1265, the input unit 1270, the output unit 1275, in some example implementations described above. For example, the flow of one or more processes or implementations may be controlled by logic unit 1260 alone or in conjunction with API unit 1265. The input unit 1270 may be configured to obtain input for the calculations described in the example implementations, and the output unit 1275 may be configured to provide an output based on the calculations described in example implementations.

Processor(s) 1210 can be configured to measure, at a high sample rate, data relating to an operation of the system over a first time period. The processor(s) 1210 may also be configured to produce a 2D time-and-frequency input data set by applying a wavelet transform to the measured data. Processor(s) 1210 may, in some aspects, be configured to apply, to each set of time-windows at each of the plurality of scales, a wavelet associated with the range of frequencies corresponding to the scale in the plurality of scales. The processor(s) 1210 may further be configured to generate a set of one or more values associated with one or more system characteristics by processing the 2D time-and-frequency input data set using an FNN.

Processor(s) 1210 may, in some aspects, be configured to provide the 2D time-and-frequency input data set to the FNN as input. The processor(s) 1210 may also be configured to generate, using the FNN, an output data set. The processor(s) 1210 may also be configured to provide the output data set as an input to a fully connected neural network (FCNN), wherein the generated set of one or more values associated with the one or more system characteristics is the output of the FCNN.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed:

1. A method for predicting a characteristic of a system, comprising:
measuring, at a high sample rate, data relating to an operation of the system over a first time period;
producing a two-dimensional (2D) time-and-frequency, first input data set by applying a wavelet transform to the measured data; and
generating a set of one or more values associated with one or more system characteristics by processing the 2D time-and-frequency, first input data set using a functional neural network (FNN).

2. The method of claim 1, wherein generating the set of one or more values associated with the one or more system characteristics comprises:
providing the 2D time-and-frequency, first input data set to the FNN as input;
generating, using the FNN, an output data set; and
providing the output data set as a second input to a fully connected neural network (FCNN), wherein the generated set of one or more values associated with the one or more system characteristics is the output of the FCNN.

3. The method of claim 2, wherein the output data set is associated with a set of latent features of the 2D time-and-frequency input data set.

4. The method of claim 1, wherein measuring the data relating to the operation of the system comprises continuously measuring the data, at the high sample rate, over the first time period.

5. The method of claim 1, wherein the first time period is divided into a set of time-windows at each of a plurality of scales with each scale in the plurality of scales corresponding to a range of frequencies represented in the 2D time-and-frequency, first input data set.

6. The method of claim 5, wherein applying the wavelet transform to the measured data to produce the 2D time-and-frequency, first input data set comprises:
applying, to each set of time-windows at each of the plurality of scales, a wavelet associated with the range of frequencies corresponding to the scale in the plurality of scales.

7. The method of claim 6, wherein each set of time-windows is a set of equal-size time-windows and the wavelet associated with each range of frequencies spans the equal-size time-windows in the set of equal-size time-windows associated with the range of frequencies.

8. The method of claim 1, further comprising:
measuring, at the high sample rate, additional data relating to the operation of the system over a second time period; and
producing an additional 2D time-and-frequency, third input data set by applying the wavelet transform to the measured additional data relating to the operation of the system over the second time period, wherein generating the set of one or more values associated with the one or more system characteristics further comprises processing the additional 2D time-and-frequency, third input data set using the FNN.

9. The method of claim 1, wherein the measured data is one of (1) vibration data, (2) acoustic data, or (3) other time-varying data relating to an operation of the system.

10. The method of claim 1, wherein the one or more system characteristics comprises at least one of a remaining useful life of the system, a probability of failing within a second time period following the first time period, or a detected anomaly.

11. An apparatus for predicting a characteristic of a system, comprising:
a memory; and
at least one processor coupled to the memory configured to:
measure, at a high sample rate, data relating to an operation of the system over a first time period;
produce a two-dimensional (2D) time-and-frequency, first input data set by applying a wavelet transform to the measured data; and
generate a set of one or more values associated with one or more system characteristics by processing the 2D time-and-frequency, first input data set using a functional neural network (FNN).

12. The apparatus of claim 11, wherein the at least one processor is configured to generate the set of one or more values associated with the one or more system characteristics by configuring the at least one processor to:
provide the 2D time-and-frequency, first input data set to the FNN as input;
generate, using the FNN, an output data set; and
provide the output data set as a second input to a fully connected neural network (FCNN), wherein the generated set of one or more values associated with the one or more system characteristics is the output of the FCNN.

13. The apparatus of claim 12, wherein the output data set is associated with a set of latent features of the 2D time-and-frequency input data set.

14. The apparatus of claim 11, wherein the at least one processor is configured to measure the data relating to the operation of the system by continuously measuring the data, at the high sample rate, over the first time period.

15. The apparatus of claim 11, wherein the first time period is divided into a set of time-windows at each of a plurality of scales with each scale in the plurality of scales corresponding to a range of frequencies represented in the 2D time-and-frequency input data set.

16. The apparatus of claim 15, wherein applying the wavelet transform to the measured data to produce the 2D time-and-frequency, first input data set comprises:
applying, to each set of time-windows at each of the plurality of scales, a wavelet associated with the range of frequencies corresponding to the scale in the plurality of scales.

17. The apparatus of claim 16, wherein each set of time-windows is a set of equal-size time-windows and the wavelet associated with each range of frequencies spans the equal-size time-windows in the set of equal-size time-windows associated with the range of frequencies.

18. The apparatus of claim 11, the at least one processor further configured to:
measure, at the high sample rate, additional data relating to the operation of the system over a second time period; and
produce an additional 2D time-and-frequency, third input data set by applying the wavelet transform to the measured additional data relating to the operation of the system over the second time period, wherein generating the set of one or more values associated with the one or more system characteristics further comprises processing the additional 2D time-and-frequency, third input data set using the FNN.

19. The apparatus of claim 11, wherein the measured data is one of (1) vibration data, (2) acoustic data, or (3) other time-varying data relating to an operation of the system.

20. The apparatus of claim 11, wherein the one or more system characteristics comprises at least one of a remaining useful life of the system, a probability of failing within a second time period following the first time period, or a detected anomaly.
